(19) United States
(12) Patent Application Publication
(10) Pub. No.: US 2008/0075943 A1
(43) Pub. Date: Mar. 27, 2008

(54) Solidified molded article including additive body having a varying diameter, amongst other things

(75) Inventor: Alireza Mortazavi, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/527,813

(22) Filed: Sep. 27, 2006

(51) Int. Cl. B32B 27/04

(52) U.S. Cl. 428/297.4

(57) ABSTRACT

Disclosed is: (i) a solidified molded article, (ii) a molding material, (iii) an additive, (iv) a molding system, (v) a method and/or (vi) a reinforcement-forming system, amongst other things.

### TECHNICAL FIELD

The present invention generally relates to, but is not limited to, molding systems, and more specifically the present invention relates to, but is not limited to: (i) a solidified molded article, (ii) a molding material, (iii) a reinforcement, (iv) a molding system, (v) a method and/or (vi) a reinforcement-forming system, amongst other things.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

In 1998, a technical article was published (Article title: A Composite Reinforced With Bone-Shaped Short Fibers; Authors: Zhu, Valdez, Shi, Lovato, Stout, Zhou, Butt, Blumenthal, and Lowe; Publication Name: Scripta Materialia, Vol. 38. No. 9, pp. 1321 to 1325: 1998). The article discloses short-fiber composites that have multiple advantages compared to those reinforced with long continuous filaments. They can be adapted to conventional manufacturing techniques and consequently cost significantly less to fabricate. Obtaining optimum strength and toughness in short-fiber composites remains a challenge. The extensive world-wide effort to design and optimize properties of continuous fiber composites through control of fiber-matrix interfaces properties is not directly applicable to short-fiber composites. In fact, these interfaces play a critical role and, in many cases, become a limiting factor in improving mechanical properties. For a short fiber composite, a strong interface is desirable to transfer load from the matrix to the fibers. A stronger interface can increase the effective length of the fiber that carries load. However, with a strong interface it is difficult to avoid fiber breakage caused by fiber stress concentrations interacting with the stress field of an approaching crack. Although fracture toughness is enhanced by crack bridging in weakly bonded continuous filament composites, this mechanism is limited in short-fiber composites because a weak interface significantly increases the ineffective fiber length. Compromising interfacial bond strength in short-fiber composites may result in complete fiber interfacial debonding and pullout. This may produce a significant loss of the composite strength with only a minimal improvement in the composite toughness.

In 1999, another technical article was published (Article title: Mechanical Properties Of Bone-Shaped-Short-Fiber Reinforced Composites; Authors: Zhu1, Valdez, Beyerlein1, Zhou, Liu, Stout1, Butt and Lowe; Publication Name: Aria mater (Acta Metallurgica Inc.) Vol 47, No. 6, pp. 1767 to 1781: 1999). The article discloses short-fiber composites. The short-fiber composites usually have low strength and toughness relative to continuous fiber composites, an intrinsic problem caused by discontinuities at fiber ends and interfacial debonding. In this work a model polyethylene bone-shaped-short (BSS) fiber-reinforced polyester—matrix composite was fabricated to prove that fiber morphology, instead of interfacial strength, solves this problem. Experimental tensile and fracture toughness test results show that BSS fibers can bridge matrix cracks more effectively, and consume many times more energy when pulled out, than conventional straight short (CSS) fibers. This leads to both higher strength and fracture toughness for the BSS-fiber composites. A computational model was developed to simulate crack propagation in both BSS- and CSS-fiber composites, accounting for stress concentrations, interface debonding, and fiber pull-out. Model predictions were validated by experimental results and will be useful in optimizing USS-fiber morphology and other material system parameters.

In 2001, yet another technical article was published (Article title: On the influence of fiber shape in bone-shaped short-fiber composites; Authors: Beyerleina, Zhua and Maheshb; Publication Name: Composites Science and Technology 61 (2001) pp. 1341 to 1357). The article discloses composite materials reinforced by bone-shaped short (BSS) fibers enlarged at both ends. These reinforced materials are well-known to have significantly better strength and toughness than those reinforced by conventional, short, straight (CSS) fibers with the same aspect ratio. Comparing the fracture characteristics of double-cantilever-beam specimens made of BSS and CSS fiber composites reveals the distinct mechanisms responsible for the toughness enhancement provided by the BSS fiber reinforcement. Enlarged BSS fiber ends anchor the fiber in the matrix and lead to a significantly higher stress to pull out than that required for CSS fibers, altering crack propagation characteristics. To study BSS fiber-bridging capability further, the effects of increasing the size of the enlarged fiber end on the pull-out characteristics and identify the sequence of failure mechanisms involved in the pull-out process were examined. However, large micro-cracks initiated at the enlarged ends can potentially mask the toughening enhancements provided by BSS fibers. To understand the influence of fiber-end geometry on debond initiation at the fiber ends, the interfacial stresses around fiber ends varying in geometry using an elastic finite-element model was analyzed.

In 2002, yet another technical article was published (Article title: Bone-shaped short fiber composites—an overview; Authors: Zhu and Beyerlein; Publication Name: Materials Science and Engineering A326 (2002) 208 to 227). The article discloses a new class of short fiber composites, in which the ends of the short fibers were enlarged and have been studied. Because of their geometry, these short fibers were named bone-shaped short (BSS) fibers. It was found in several composite systems that the BSS fibers can simultaneously improve both the strength and toughness of composites, and the mechanisms for such improvements vary with mechanical properties of the composite constituents. The strength increase resulted from the effective load transfer from the matrix to the fibers through mechanical interlocking at the enlarged fiber ends. The toughness increase resulted from one or several mechanisms, including: reduction in stress concentration in a brittle fiber reinforced composite with weak fiber/matrix interfacial bonding; higher fiber pullout resistance when the BSS fibers bridging a matrix crack are pulled out, with the enlarged ends attached and perhaps deformed; and plastic deformation of ductile fibers. Both experimental and theoretical studies have been conducted on composite mechanical properties and fractography, fiber pullout, and stress analysis. This paper reviews recent developments in BSS-fiber composites as well as discusses current issues and future directions in this emerging field. Specifically, section 3, sub-section 3.1 (manufacturing) discloses a major road block to the commercialization of BSS-fiber composites, which is the production of BSS fibers in a practical and economic fashion, especially advanced ceramic fibers. The ceramic fibers are for advanced composites for applications in automobile, aerospace and other industries. It is difficult and uneconomical to process currently available ceramic fibers into BSS fibers. However, continuous fibers with nodules along their length can be produced by current fiber production technologies with some modifications. When chopped, these fibers will act like BSS fibers although there may be more than one nodule on each short fiber. Other types of BSS fibers are steels or polymer fibers for the concrete infrastructure industry. Commercial quantities of BSS-steel fibers/wires can be readily fabricated from commercial steel wires using currently available industrial facilities. In fact, such developments are currently in progress, and, to date, small quantities of RSS-steel wires are already commercially available.

### SUMMARY

What is required is, amongst other things, a solution for molding molded articles including an additive body having a length, and a varying diameter along the length of the additive body.

According to a first aspect of the present invention, there is provided, amount other things: a solidified molded article, including, amongst other things: (i) a solidified matrix, and (ii) a fiber embedded in the solidified matrix, the fiber including an additive body having: (a) a length, and (b) a varying diameter along the length of the additive body.

According to a second aspect of the present invention, there is provided, amount other things: a molding material, including, amongst other things: (i) a molten matrix, and (ii) a fiber embedded in the molten matrix, the fiber including an additive body having: (a) a length, and (b) a varying diameter along the length of the additive body.

According to a third aspect of the present invention, there is provided, amount other things: a fiber, including, amongst other things: an additive body having (i) a length, and (ii) a varying diameter along the length of the additive body, the additive body embeddable in a molten matrix of a molding material usable for molding a solidified molded article.

According to a fourth aspect of the present invention, there is provided, amount other things: a molding system, including, amongst other things: (i) an extruder configured to process a molding material, the molding material having: (a) a molten matrix, and (b) a fiber embedded in the molten matrix, the fiber including an additive body having: (A) a length, and (B) a varying diameter along the length of the additive body.

According to a fifth aspect of the present invention, there is provided, amount other things: a method, including, amongst other things: varying a diameter of an additive body of a fiber along a length of the additive body, the additive body embeddable in a matrix of a molding material usable for molding a solidified molded article.

According to a sixth aspect of the present invention, there is provided, amount other things: a reinforcement-forming system, including, amongst other things: a reinforcement-diameter varying mechanism configured to vary a diameter of an additive body of a fiber along a length of the additive body, the additive body embeddable in a matrix of a molding material usable for molding a solidified molded article.

A technical effect, amongst other technical effects, of the aspects of the present invention is a way to manufacture molded articles including an additive body having a length, and a varying diameter along the length of the additive body. It appears that the state of the art indicates that it was not known how to manufacture the molded article (at least it was thought of as not possible to manufacture such molded articles.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a solidified molded article according to a first exemplary embodiment (which is the preferred embodiment);

FIG. 2 is a schematic representation of reinforcement-forming systems used to form a reinforcement used in the solidified molded article of FIG. 1; and

FIG. 3 is a schematic representation of a molding system used to manufacture the solidified molded article of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

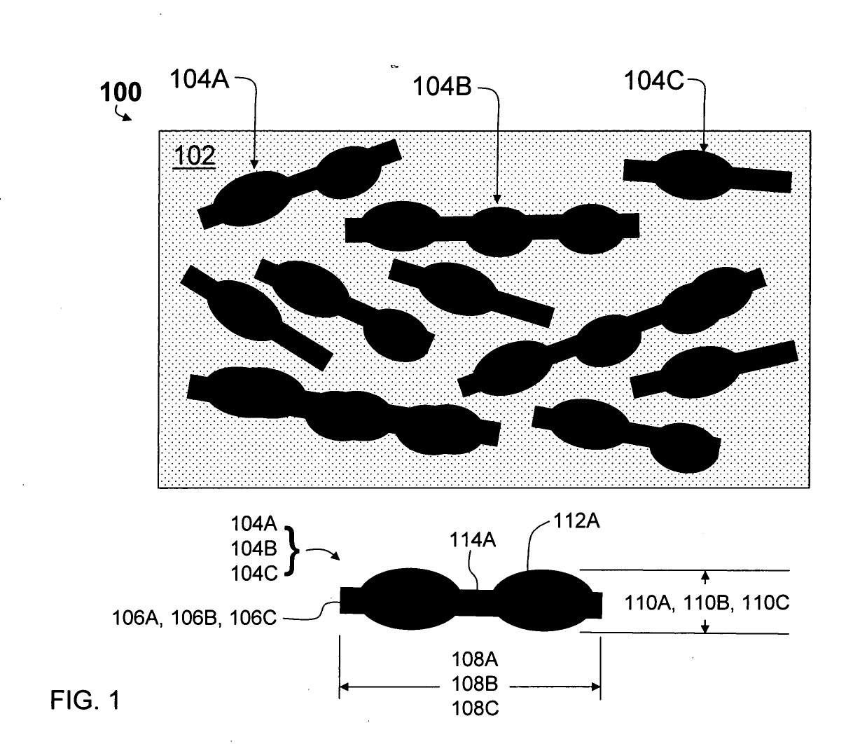

FIG. 1 is the schematic representation of a solidified molded article 100 according to the first exemplary embodiment. Generally, the solidified molded article 100 includes, possibly amongst other things (such as impurities, etc): (i) a solidified matrix 102, and (ii) an additive 104A, 104B, 104C (any one or more thereof either depicted or not depicted) embedded in the solidified matrix 102. The additive 104A includes two nodules. The additive 104B includes three nodules. The additive 104C includes one nodule. Generally, any one of the additives may include one or more nodules. The additive 104A, 104B, 104C includes, amongst other things, an additive body 106A, 106B, 106C. The additive body 106A, 106B, 106C has: (i) a length 108A, 108B, 108C, and (ii) a varying diameter 110A, 110B, 110C along the length 108A, 108B, 108C of the additive body 106A, 106B, 106C. A technical effect is that the varying diameter 110A, 110B, 110C improves mechanical properties of the solidified matrix 102, such as strength, etc. The presence of the additive 104A, 104B, 104C makes it more difficult to pull apart the solidified matrix 102. By way of example, the additive 104A, 104B, 104C may include any one of a fiber, a reinforcement, a particle, a polymer and any combination and permutation thereof. Preferably, the additive 104A, 104B, 104C substantially includes a glass fiber. By way of example, the solidified matrix 102 includes any one of a polypropylene material, a thermoplastic material, a plastic material, a polymer and any combination and permutation thereof. Preferably, the solidified matrix 102 substantially includes the polypropylene material. Preferably, the additive body 106A has an hour-glass shaped profile (which may be called a boned structure), formed at least in part along the length 108A. The additive body 106A includes a distal portion 112A and also includes a midpoint portion 114A that is offset from the distal portion 112A, and the midpoint portion 114A is smaller in diameter than the distal portion 112A.

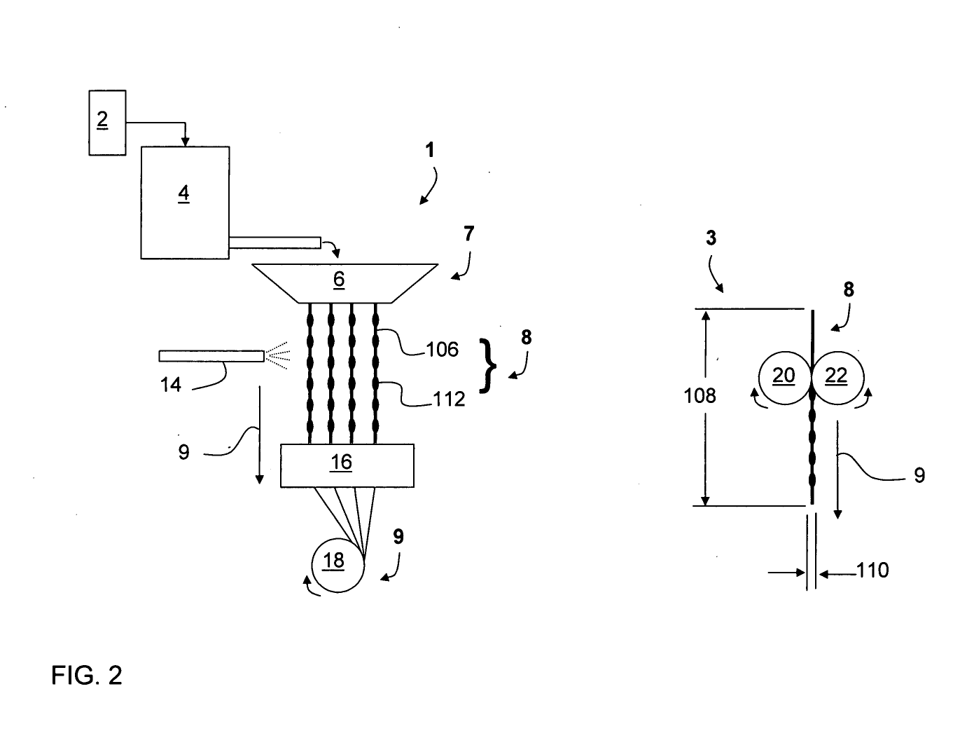

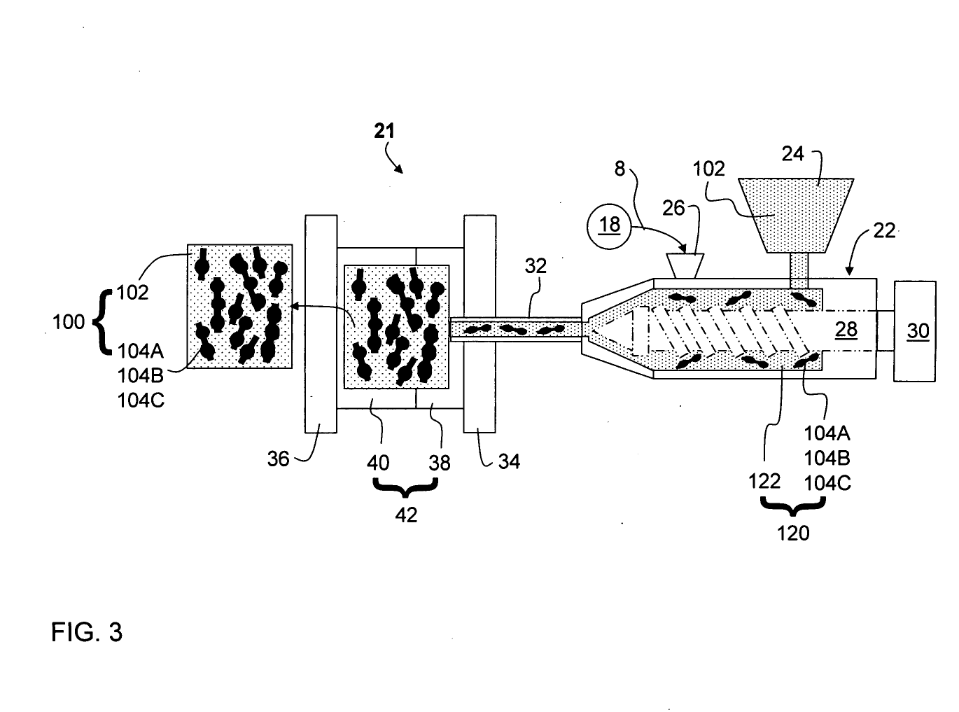

FIG. 2 is a schematic representation of reinforcement-forming systems 1 and 3 (hereafter referred to as the “system 1, 3” respectively) used to form a reinforcement 8 used in the solidified molded article 100 of FIG. 1. The system 1, 3 includes, amongst other things: (i) a reinforcement-diameter varying mechanism 9 that is configured to vary the diameter 110 of the additive body 106 of the additive 8 along the length 108 of the additive body 106. With reference to FIG. 3, the additive body 106 is embeddable in a matrix 122 of a molding material 120 usable for molding a solidified molded article 100; a molding system 21 is used to mold or manufacture the solidified molded article 100. Preferably, the additive body 106A, 106B, 106C is inelastically deformable at least in part; and more specifically, the additive body 106A, 106B, 106C is inelastically deformable at least in part at a forming temperature and/or at a forming pressure.

Preferably, the system 1, 3 includes a former 7 that is configured to form the additive 8. The former 7 is cooperative with the reinforcement-diameter varying mechanism 9. The former 7 includes a furnace 4 that is configured to receive and melt a material 2 (such as glass for example). The former 7 includes a bushing 6 that is positionable relative to the furnace 7. The bushing 6 is configured to receive the material 2 melted by the furnace 4. The bushing 6 is also configured to permit drawing of the material 2 so as to form the additive 8 (preferably, gravity is used to draw the glass from the bushing 6). The reinforcement-diameter varying mechanism 9 includes a take-up reel 18 that is configured to rotate so as to impart a varying pulling force to the additive 8 (by pulling on the reinforcement or the fiber, the diameter of the reinforcement or the fiber is made to vary). The pulling force imparted to the additive 8 causes the additive to travel with a varying speed. Alternatively, the system 3 includes the reinforcement-diameter varying mechanism 9 that has a cam surface 20 that is placed against or abuts against the reinforcement, and then the cam surface 20 imparts, at least in part, a profile on the additive 8 (and the additive 8 may travel at either (i) a constant speed or (ii) a varying speed). A bath 16 is configured to place a coating, at least in part, on the additive 8. A spray nozzle 14 is configured to spray a coolant, at least in part, on the additive 8. Alternatively, the spray nozzle 14 is configured to spray a coating, at least in part, on the additive 8 (without having to use the bath 16).

FIG. 3 is a schematic representation of a molding system 21 used to manufacture the solidified molded article 100 of FIG. 1. The molding system 21, includes, amongst other things: an extruder 22 that is configured to process a molding material 120. The extruder 22 is configured to operate in an injection mode, a compression mode and any combination and permutation thereof. The molding material 120, includes, amongst other things: a molten matrix 122, and the additive 104A, 104B, 104C (any one or more thereof) embedded in the molten matrix 122. The system 21 also includes, amongst other things, (i) a machine nozzle 32, (ii) a stationary platen 34 and (iii) a movable platen 36. A mold 42 includes: (i) a stationary mold portion 38 (that is mounted to the stationary platen 34), and (ii) a movable mold portion 40 (that is mounted to the movable platen 36). The system 21 further includes, amongst other things, tangible subsystems, components, sub-assemblies, etc, that are known to persons skilled in the art. These items are not depicted and not described in detail since they are known. These other things may include (for example): (i) tie bars (not depicted) that operatively couple the platens 34, 36 together, and/or (ii) a clamping mechanism (not depicted) coupled to the tie bars and used to generate a clamping force that is transmitted to the platens 34, 26 via the tie bars (so that the mold 42 may be forced to remain together while a molding material is being injected in to the mold 42). These other things may include: (iii) a mold break force actuator (not depicted) coupled to the tie bars and used to generate a mold break force that is transmitted to the platens 34, 36 via the tie bars (so as top break apart the mold 42 once the molded article 100 has been molded in the mold 42), and/or (iv) a platen stroking actuator (not depicted) coupled to the movable platen 36 and is used to move the movable platen 36 away from the stationary platen 34 so that the molded article 100 may be removed from the mold 42, and (vi) hydraulic and/or electrical control equipment, etc. A screw 28 is disposed in the extruder 22 and the screw 28 is connected to a drive unit 30. A hopper 24 is operatively connected to the extruder 22 as to feed the matrix 102 into the extruder 22. An auxiliary hopper 26 is also attached to the extruder and is used to feed the reinforcement to 8 to the extruder 22.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. A solidified molded article, comprising:
a solidified matrix; and
an additive embedded in the solidified matrix, the additive including an additive body having: (i) a length, and (ii) a varying diameter along the length of the additive body.

2. The solidified molded article of claim 1, wherein the additive includes any one of a fiber, a reinforcement, a particle, a polymer and any combination and permutation thereof.

3. The solidified molded article of claim 1, wherein the additive body is inelastically deformable at least in part at forming conditions of the additive body.

4. The solidified molded article of claim 1, wherein the additive body has an hour-glass shaped profile, formed at least in part along the length.

5. The solidified molded article of claim 1, wherein the additive body includes a distal portion and also includes a midpoint portion offset from the distal portion, the midpoint portion is smaller in diameter than the distal portion.

6. The solidified molded article of claim 1, wherein the solidified matrix includes any one of a polypropylene material, a thermoplastic material, a plastic material, a polymer and any combination and permutation thereof.

7. A molding material, comprising:
a molten matrix; and
an additive embedded in the molten matrix, the additive including an additive body having:
a length; and
a varying diameter along the length of the additive body.

8. The molding material of claim 7, wherein the additive includes any one of a fiber, a reinforcement, a particle, a polymer and any combination and permutation thereof.

9. The molding material of claim 7, wherein the additive body is inelastically deformable at least in part at forming conditions of the additive body.

10. The molding material of claim 7, wherein the additive body has an hour-glass shaped profile, formed at least in part along the length.

11. The molding material of claim 7, wherein the additive body includes a distal portion and also includes a midpoint portion offset from the distal portion, the midpoint portion is smaller in diameter than the distal portion.

12. The molding material of claim 7, wherein the solidified matrix includes any one of a polypropylene material, a thermoplastic material, a plastic material, a polymer and any combination and permutation thereof.

13. An additive, comprising:
an additive body having: (i) a length, and (ii) a varying diameter along the length of the additive body, the additive body embeddable in a molten matrix of a molding material usable for molding a solidified molded article.

14. The additive of claim 13, wherein the additive includes any one of a fiber, a reinforcement, a particle, a polymer and any combination and permutation thereof.

15. The additive of claim 13, wherein the additive body is inelastically deformable at least in part at forming conditions of the additive body.

16. The additive of claim 13, wherein the additive body has an hour-glass shaped profile, formed at least in part along the length.

17. The additive of claim 13, wherein the additive body includes a distal portion and also includes a midpoint portion offset from the distal portion, the midpoint portion is smaller in diameter than the distal portion.

18. The additive of claim 13, wherein the solidified matrix includes any one of a polypropylene material, a thermoplastic material, a plastic material, a polymer and any combination and permutation thereof.

19. A molding system, comprising:
an extruder configured to process a molding material, the molding material having:
a molten matrix; and
an additive embedded in the molten matrix, the additive including an additive body having: (i) a length, and (ii) a varying diameter along the length of the additive body.

20. The molding system of claim 19, wherein the extruder is configured to operate in an injection mode, a compression mode and any combination and permutation thereof.

21. A method, comprising:
varying a diameter of an additive body of an additive along a length of the additive body, the additive body embeddable in a matrix of a molding material usable for molding a solidified molded article.

22. The method of claim 21, further comprising:
imparting an hour-glass shaped profile to the additive body, the hour-glass shaped profile formed at least in part along the length.

23. The method of claim 21, further comprising:
forming a midpoint portion of the additive body that is smaller in diameter than a distal portion of the additive body.

24. The method of claim 21, further comprising:
drawing the additive.

25. The method of claim 21, further comprising:
cooling the additive.

26. A reinforcement-forming system, comprising:
a reinforcement-diameter varying mechanism configured to vary a diameter of an additive body of an additive along a length of the additive body, the additive body embeddable in a matrix of a molding material usable for molding a solidified molded article.

27. The reinforcement-forming system of claim 26, further comprising:
a former configured to form the additive, the former being cooperative with the reinforcement-diameter varying mechanism.

28. The reinforcement-forming system of claim 27, wherein the former includes a furnace configured to receive and melt a material.

29. The reinforcement-forming system of claim 28, wherein the former includes a bushing positionable relative to the furnace, the bushing configured to receive the material melted by the furnace, and configured to permit drawing of the material so as to form the additive.

30. The reinforcement-forming system of claim 26, wherein the reinforcement-diameter varying mechanism includes:
a take-up reel configured to rotate so as to impart a varying pulling force to the additive.

31. The reinforcement-forming system of claim 26, wherein the reinforcement-diameter varying mechanism includes:
a cam surface configured to impart, at least in part, a profile on the additive.

32. The reinforcement-forming system of claim 26, further comprising:
a bath configured to place a coating, at least in part, on the additive.

33. The reinforcement-forming system of claim 26, further comprising:
a spray nozzle configured to spray a coolant, at least in part, on the additive.

34. The reinforcement-forming system of claim 26, further comprising:
a spray nozzle configured to spray a coating, at least in part, on the additive.
